(19) United States
(12) Patent Application Publication
(10) Pub. No.: US 2004/0022057 A1
(43) Pub. Date: Feb. 5, 2004

(54) Led lamp for signal light

(76) Inventor: Gye Seon Lee, Seoul (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/381,621

(22) PCT Filed: Oct. 10, 2001
(86) PCT No.: PCT/KR01/01703

(30) Foreign Application Priority Data
Oct. 10, 2000 (KR) 2000/59561
Jul. 10, 2001 (KR) 2001/41129

(51) Int. Cl. F21V 1/00

(52) U.S. Cl. 362/238; 362/249; 362/252; 362/800

(57) ABSTRACT

Disclosed herein is an LED lamp for a traffic signal. The LED lamp generally includes a threaded electrode portion, a board holder and a plurality of PCBs. The threaded electrode portions functions to mount a lamp body to a head socket of the traffic signal is an insertion manner. The board holder is mounted on the threaded electrode portion. The PCBs are multi-layered on the board holder and provided with a plurality of LEDs on their entire circumferences. The LEDs fixed on the PCB mounted on an upper portion of the lamp body are vertically mounted so as to face the head of the traffic signal, while the other LEDs fixed on another PCBs are slantingly arranged without overlapping one another so as to face a reflector.

### TECHNICAL FIELD

The present invention relates generally to an LED lamp for a traffic signal, and more particularly, to an LED lamp, which is capable of simplifying the components of the LED lamp mounted on a traffic signal post, significantly decreasing the electric power consumption of the LED lamp, and highly increasing the brightness of the LED lamp.

### BACKGROUND ART

With the development of industries, the population of a city and the number of vehicles have gradually increased. Accordingly, the traffic signals are provided to control the movement of vehicles, thereby facilitating the passage of the pedestrians.

In general, traffic signals are adapted to display red, yellow and green lights by emitting the lights from electric lamps through colored globes.

However, a common traffic signal having an electric lamp consumes electric power of 100 Watts per lamp. As the number of the traffic signals increases, the amount of electric power consumption increases by geometric progression. The electric lamp does not have a long life span due to heat produced from the lamp itself, and has to be frequently replaced as a filament of the lamp breaks due to the vibration of the running vehicles. As a result, maintenance of the electric lamp requires a large expenditure of manpower and funds, and causes a traffic disruption. Under some circumstances, the maintenance contributes to causing a traffic accident.

Furthermore, when intense sunlight is reflected from the surface of a lens, there occurs a so-called sun phantom phenomenon whereby the driver can hardly distinguish from whether the traffic signal is turned on or not.

Accordingly, the common lamp is vulnerable to such a phenomenon that drivers may have problems in recognizing whether the traffic signal is turned on/off. The lamp shows unsteady and umsatisfactory brightness, and the visibility is low so that the driver or pedestrian may have difficulties in recognizing the signal. In addition, the lamp is subject to an overload due to an unstable voltage and current applied thereto, or is not turned on due to a low voltage and so on. These are seen as disadvantages in the management of the traffic signal.

In order to overcome the problems of the above-described electric lamp type traffic signal, an LED lamp type traffic signal is developed and used in Europe, North America and so on. In the LED lamp type traffic signal, the electric power consumption is reduced by at least 80% and brightness is increased at least two times, compared with the existing electric lamp type traffic signal, thereby contributing greatly to the traffic accident prevention. Further, the maintenance cost is minimized, the visibility is enhanced and a sun phantom phenomenon is avoided. Nevertheless, this LED lamp type traffic signal requires further development with respect to performance, and has various problems to replace the existing electric lamp type traffic signal.

An LED lamp type traffic signal, which has been used in Europe and North America and is under development in Korea, is disclosed in national Utility Model No. 163349. In the traffic signal, a power supply and a dimming controller, which are connected to an external power source, are installed in a housing. A PCB with an LED inserted therein is connected to the power supply and the dimming controller, and an optical lens is screwed into the housing. Such a structure is inserted into a head of the traffic signal.

However, in order to replace the existing electric lamp type traffic sign with this LED lamp type traffic signal, all components have to be replaced except for the column. Accordingly, regarding the LED's cost, the replacement of the electric lamp type signal with the LED traffic signal is still more expensive than the installation of a new one, and causes the basic cost to increase because at least about 400 LEDs are mounted on a traffic signal. Furthermore, even if at least 400 LEDs are inserted, the traffic signal's lamp satisfy whole properties required as the traffic signal at only a middle portion of the lamp, but has the brightness lowering as approaching closer to the lamp radially outward, so that this phenomenon decreases the function as the traffic signal. This LED lamp consumes electric power of 5 to 20 Watt, thereby requiring more technical development to decrease the electric power consumption. In addition, when the traffic signal requires repair, the head has to be first disassembled, causing a troublesome situation. Further the traffic signal is stopped for a long time, and the cost of maintaining the traffic signal is high.

On the other hand, a detachable epoxy LED lamp and method for producing the same is disclosed in Korean Pat. No. 210713. However, this lamp is used for common illumination so that it does not have sufficient luminous intensity for application as a traffic signal. This lamp is so designed that its circuit board socket and globe cap are integrated by an epoxy package, so this lamp has to be discarded in the cases of the breakdown of LED as well as the lamp. Moreover, this lamp is not practically used because the intense heat thereof shortens the lifetime, and has several problems in its use for a traffic signal exposed to vibrations from the passing vehicles.

Furthermore, a bulb-type LED traffic signal is disclosed in Korean Pat. Publication No. 1999-78991, wherein a case acting as a heat dissipating plate has a rough shape on the whole external surface, and all the components except for the case have a complicated construction so that they are difficult to fabricate, thereby increasing the fabrication cost. In addition, the LED has a low luminosity or brightness and a high weight, and one of the components, i.e. a power supply has a power factor of 0.6 to 0.7 still lower than the standard of 0.9. Accordingly, this traffic signal fails to meet the power factor or the electric power consumption, and has a much high-frequency content so that it has a possibility to adversely affect on the surrounding components and thus cannot satisfy the practical performance test.

In addition, an LED lamp for a traffic signal is disclosed in Japanese Pat. Publication No. 2000-276693. The lamp has a flat type circuit board rather than a bulb type circuit board, so that it has a dead zone when an LED is turned on, thereby decreasing the luminosity or brightness. The lamp is also designed without a power factor. If the circuit board is damaged, it is impossible to replace.

Furthermore, an LED lamp disclosed in U.S. Pat. No. 5,561,346 requires AC voltage to be transformed into DC one, so that it has to be provided with a separate power supply. As a result, the LED lamp is not appropriate for use in Korea. The circuit board for the lamp has a semi-circular shape so that it is difficult to manufacture the lamp and to mount a circuit in practice. Mounting the LED in the circuit board proceeds manually, which causes many inconveniences to connect power supply wires to the LEDs.

Furthermore, a lamp disclosed in Korean Patent Publication No. 2000-30723 has a circular disc shape, resulting in a difficulty to dispose a separate optical processing plate and high manufacturing cost.

Finally, a lamp disclosed in Japanese Patent Publication Hei9-65807 requires the precise fabrication of a reflective plate and the provision of all the electrical components such as a power supply with a controller due to only provision with a LED, and thus replacement of the lamp is impossible under normal circumstances. The lamp has a hexagonal shape, and thus presents a poor appearance since the angled contour can be seen from the outside, moreover a PCB shaped as a hexagon is difficult to connect with the LED and its design becomes highly complicated to lead to a lowered assembly productivity and high manufacturing cost.

### DISCLOSURE OF THE INVENTION

Accordingly, the present invention has been made keeping in mind the above-descried problems occurring in the prior art, and an object of the present invention is to provide an LED lamp for a traffic signal, whose components are simplified to minimize the manufacturing cost and reduce assembly time, thereby improving the assembly productivity.

Another object of the present invention is to provide an LED lamp for a traffic signal, which is capable of significantly decreasing the electric power consumption of the LED lamp, increasing the brightness of the LED lamp two times as compared with a conventional electric lamp type preventing a sun phantom phenomenon due to intense sunlight, and preventing traffic accidents by improving drivers' discriminating power with its excellent visibility.

Still another object of the present invention is to provide an LED lamp for a traffic signal, which is capable of being used with equipments for conventional traffic signals, thereby reducing the replacement cost of the traffic signal.

In order to accomplish the above object, the present invention provides an LED lamp for a traffic signal, comprising: a threaded electrode portion for mounting a lamp body to a head socket of the traffic signal in an insertion manner; a board holder mounted on the threaded electrode portion; and a plurality of PCBs multi-layered on the board holder and provided with a plurality of LEDs on their entire circumferences, the LEDs fixed on the PCB mounted on an upper portion of the lamp body being vertically mounted so as to face the head of the traffic signal, the other LEDs fixed on another PCBs being slantingly arranged without overlapping one another so as to face a reflector.

Preferably, the PCBs each have a doughnut-shaped disc configuration.

Preferably, the PCBs have diameters that sequentially decrease from a PCB adjacent to the board holder to a PCB away from the board holder. Preferably, the PCBs are each provided with a plurality of mounting grooves along its outer edges at regular intervals so as to prevent mutual interference of the LEDs upon mounting the PCBs.

Preferably, the LEC lamp further comprises electric connectors mounted on upper and lower portions of the PCBs to fix the PCBs by regulating spacing between two PCBs and to supply electric power, each of the electric connectors having a threaded protrusion and a threaded recess.

Preferably, the LED lamp further comprises a radiator plate for securely holding the LEDs fixedly mounted on the PCB on the upper portion of the lamp body and efficiently radiating heat from the lamp.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing the entire construction of an LED lamp in accordance with the present invention;

FIG. 2 is an exploded view of FIG. 1;

FIG. 3 is a sectional view of FIG. 1;

FIG. 4 is a front view showing the PCB of the present invention; and

FIG. 5 is a side view of FIG. 4.

### BEST MODE FOR CARRYING OUT THE INVENTION

Hereinafter, a LED lamp in accordance with the present invention is described in detail with reference to the accompanying drawings.

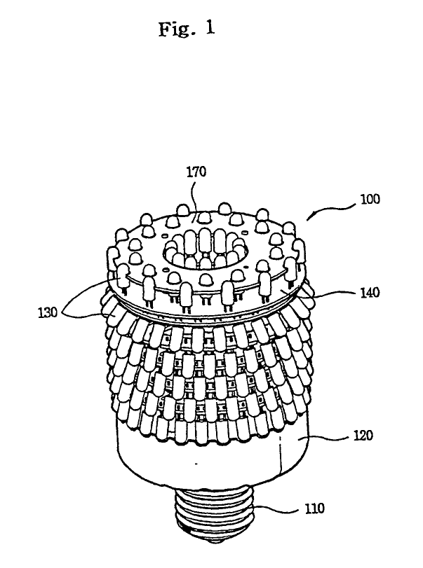

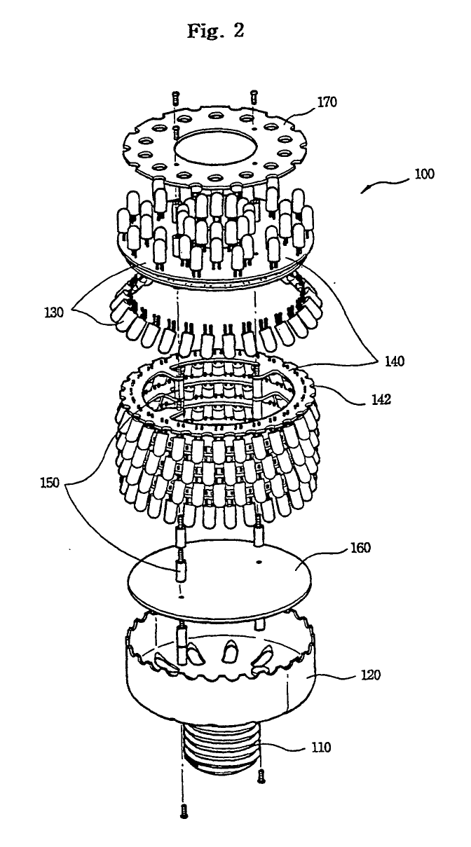

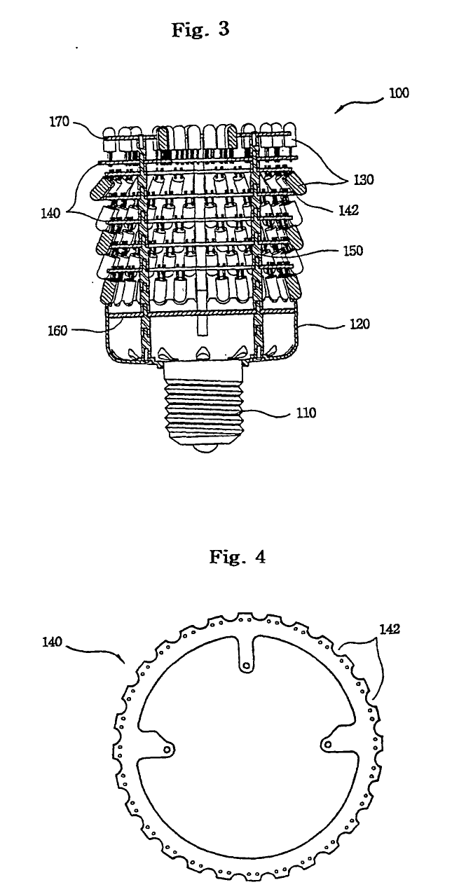

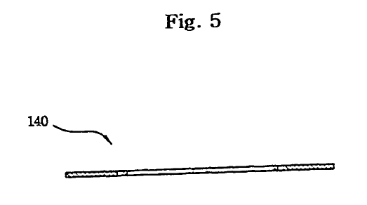

FIG. 1 is a perspective view showing the entire construction of an LED lamp in accordance with the present invention, FIG. 2 is an exploded view of FIG. 1, FIG. 3 is a sectional view of FIG. 1, FIG. 4 is a front view shoving the PCB of the present invention, and FIG. 5 is a side view of FIG. 4.

The LED lamp mounted on a traffic signal (not shown) includes a lamp body 100 having a threaded electrode portion 110 at the lower central portion thereof for detachably mounting the lamp body into a head socket of the traffic signal by inserting and turning the same. On the threaded electrode portion 110 is mounted a cylindrical or semi-spherical circuit board holder 120.

On the circuit board holder 120 is mounted a driving circuit board 160 and a plurality of PCBs 140 on which a plurality of LEDs 130 are fixedly mounted along the entire circumferences of the PCBs 140. The plurality of LEDs 130 fixedly mounted on the upper PCB 140 are vertically mounted so as to face a head of the traffic signal, and the other LEDs 130 fixedly mounted on the lower PCB 140 are slantingly arranged without overlapping one another so as to face a reflector (not shown).

Also, electronic devices mounted on the driving circuit board 160 are not illustrated for ease of illustration.

The PCBs 140 are respectively formed to have a doughnut shape and have diameters that sequentially decrease from the PCB 140 adjacent to the board holder 120 to the PCB 140 away from the board holder 120. In the outer edges of the PCBs 140 are formed a plurality of mounting grooves 142 at regular intervals so as to prevent the mutual interference of the LEDs upon mounting the PCBs.

On the upper and lower portions of the PCB 140, protruding electric connectors 150 are mounted to fix the PCBs by regulating a spacing between the adjacent PCBs and to supply electric power. Each of the electric connectors 150 has a threaded protrusion and a threaded recess into which the protrusion of another electric connector 150 is joined.

Additionally, a radiation plate 170 is attached to the uppermost PCB 140 by screws so that the LEDs 130 fixedly mounted on the uppermost PCB 140 are prevented from being removed from the uppermost PCB 140 and heat generated from the LEDs 130 can be easily dissipated from the LEDs 130 to the outside.

As illustrated in FIGS. 1 to 5, the LEDs to be mounted on the traffic signal are assembled as follows.

First, the plurality of PCBs 140 are readily stacked one over another by joining the electric connectors 150 mounted on upper and lower portions of each PCB 140 to one another after fixedly mounting the PCB 140 of the largest diameter on the board holder 120 of the lamp body 100.

In this case, the electric connectors 150 serve to constantly regulate a spacing between the PCBs and to supply electric power, thereby eliminating a process of electrical-wire connection or soldering between the adjacent PCBs, and allowing PCBs 140 to be detachably mounted. Accordingly, the number of mounted PCBs 140, on which the LEDs 130 are fixedly mounted according to the light intensity or luminous intensity of the LED lamp to be mounted, can be easily regulated.

On the board holder 120 is multi-layered a plurality of PCBs 140 on which a plurality of LEDs 130 are fixedly mounted along the circumferences of the PCBs 140. The plurality of LEDs 130 fixedly mounted on the upper PCB 140 are vertically mounted so as to face the head of the traffic signal, and the other LEDs 130 fixed on the lower PCB 140 are inclined-arranged without overlapping one another so as to face the reflector. Light from the LEDs 130 facing the reflector is concentrated without scattering from the reflector to improve the brightness, thereby uniformly distributing light from the LEDs 130 without a dead zone.

Since the PCBs 140 have a doughnut-shaped disc configuration, the manufacture and printing of PCBs 140 is easy. Also, the doughnut shape forms a space in a central portion of the multi-layered PCBs 140, which functions to efficiently radiate heat due to the operation of the LED lamp and ensure an installation space of lead wires and the like.

Additionally, the plurality of mounting grooves 142 are formed through the outer edges of the PCBs 140 at regular intervals, so the interference of the LEDs is prevented upon mounting the PCBs 140, the LEDs 130 are fixedly secured on their proper positions without error, and the entire irradiating angle of light from the LEDs 130 is constantly maintained.

Meanwhile, while the conventional LED lamp performs an SMPS circuit function after a power factor correction circuit function, the LED lamp of the invention simultaneously performs both functions of the power factor correction circuit and the SMPS circuit. While the conventional LED lamp has a small installation space and thus cannot install both of the power factor correction circuit and the SMPS circuit, the LED lamp in accordance with the present invention ensures a large installation space for installing the power factor correction circuit and the SMPS circuit simultaneously, Further, the LED lamp in accordance with the present invention can be provided with a temperature correction circuit for lowering the temperature of the LEDs against the rising of temperature of the LEDs.

### INDUSTRIAL APPLICABILITY

As described above, the present invention provides an LED lamp mounted on a traffic signal, whose components are simplified to minimize the manufacturing cost and reduce assembly time, thereby improving the assembly productivity as compared with prior art LED lamps. The LED lamp in accordance with the present invention also improves the brightness and prevents a sun phantom phenomenon due to intense sunlight, and prevents traffic accidents by its excellent visibility. The LED lamp for a traffic signal is capable of being used with the equipment of a conventional traffic signal itself, thereby reducing the mounting cost of the traffic signal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An LED lamp for a traffic signal, comprising:
a threaded electrode portion for mounting a lamp body to a head socket of the traffic signal in an insertion manner;
a board holder mounted on the threaded electrode portion; and
a plurality of PCBs multi-layered on the board holder and provided with a plurality of LEDs on their entire circumferences, the LEDs fixed on the PCB mounted on an upper portion of the lamp body being vertically mounted so as to face the head of the traffic signal, the other LEDs fixed on another PCBs being slantingly arranged without overlapping one another so as to face a reflector.

2. The LED lamp for a traffic signal in accordance with claim 1, wherein said PCBs each have a doughnut-shaped disc configuration.

3. The LED lamp for a traffic signal in accordance with claim 1, wherein said PCBs have diameters that sequentially decrease from a PCB adjacent to the board holder to a PCB away from the board holder.

4. The LED lamp for a traffic signal in accordance with claim 1, wherein said PCBs are each provided with a plurality of mounting grooves along its outer edges at regular intervals so as to prevent mutual interference of the LEDs upon mounting the PCBs.

5. The LED lamp for a traffic signal in accordance with claim 1, further comprising electric connectors mounted on upper and lower portions of the PCBs to fix the PCBs by regulating spacing between two PCBs and to supply electric power, each of the electric connectors having a threaded protrusion and a threaded recess.

6. The LED lamp for a traffic signal in accordance with claim 1, further comprising a radiator plate for securely holding the LEDs fixedly mounted on the PCB on the upper portion of the lamp body and efficiently radiating heat from the lamp.
